(19) United States
(12) Patent Application Publication
(10) Pub. No.: US 2008/0218889 A1
(43) Pub. Date: Sep. 11, 2008

(54) INFORMATION TRANSFER MASTER FOR MAGNETIC TRANSFER AND MAGNETIC TRANSFER METHOD

(75) Inventors: Sumio Kuroda, Kawasaki (JP); Hiroshi Chiba, Kawasaki (JP); Tsugito Maruyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/042,173

(22) Filed: Mar. 4, 2008

(30) Foreign Application Priority Data
Mar. 6, 2007 (JP) 2007-055916

(51) Int. Cl. G11B 5/86

(52) U.S. Cl. 360/15

(57) ABSTRACT

An information transfer master has servo information pattern to be magnetically transferred to a magnetic recording medium having a lubrication layer thereon; and a contact surface to contact the magnetic recording medium has surface free energy that is 45 mN/m or less when the servo information pattern is magnetically transferred.

The present patent application describes an information transfer master which is used when creating a servo pattern in a magnetic recording medium by way of magnetic transfer.

### BACKGROUND

According to the method wherein servo patterns are created in a magnetic recording medium by way of magnetic transfer, an information transfer master which supports minute surface irregularity patterns in magnetic bodies which correspond to transfer information (also referred to as servo signals or servo patterns) comprising synchronous signals, track number signals, head positioning signals, etc., and a magnetic recording medium (also referred to as a slave medium in the present patent application) are bonded together to apply a magnetic field for transfer, thereby transferring magnetized patterns supported by the information transfer master to the slave medium.

When recording information according to the magnetic transfer method, bonding the information transfer master and the slave medium together is important. For example, contrast in the magnetic field resulting from surface irregularities provided to the information transfer master is inversely proportional to the distance between the magnetic film and the slave medium. Therefore, a problem occurs in which the magnetic field applied to the slave medium blurs as the distance between the magnetic film and the slave medium increases and magnetic transfer patterns with a high S/N ratio can no longer be obtained. Conceivable causes of problems like this are a lubricant existing on the slave medium migrating to the information transfer master and accumulating thereupon, or contamination by outside dust or contamination from a magnetic transfer apparatus.

As a result, regarding the migration of lubricant to the information transfer master, Patent Document 1 (Japanese Unexamined Patent Application Publication No. 2001-006170) proposed a magnetic recording medium manufacturing process wherein after the magnetic film and protective film are formed, magnetic transfer is performed, then the lubricant is applied. Also, Patent Document 2 (Japanese Unexamined Patent Application Publication No. 2001-209934) proposed the application of lubricant before and after magnetic transfer. However, these proposed methods will be difficult to use in conventional processes which use a magnetic recording medium to perform magnetic transfer after the lubricant has been applied.

The aforementioned proposals are related to the slave medium, but there are also proposals relating to the information transfer master. Patent Document 3 (Japanese Unexamined Patent Application Publication No. 2003-187435) proposed a method wherein minute concave parts are formed in the bottom of concave surface irregularities in the information transfer master. Then the lubricant for the magnetic recording medium is trapped in these minute concave parts. However, this method has no effect on the convex parts which contact the slave medium, so it is difficult to claim that this method has a strong problem-solving effect. Also, even if the bonding worsens due to the effect of dust in the clean room or contamination from a magnetic transfer apparatus during the actual process, the distance between the magnetic film of the information transfer master and the slave medium increases. Especially in the case of contamination, the size of the contaminating particles is on the order of 1 micron, so a bigger problem occurs in which information cannot be recorded locally when contamination is present.

Furthermore, if the migration of lubricant onto the information transfer master causes the amount of lubricant on the magnetic recording medium to decrease, thereby losing its lubricating function, and if the head contacts the magnetic recording medium, then the head crashing problem is more likely to occur. Also, a problem can occur in which the lubricant which migrated onto the information transfer master migrates instead onto the magnetic recording medium, a thick lubrication layer forms on the surface of the magnetic recording medium, and lubricant adheres to the floating face of the slider, thereby causing head contamination or head crashing.

FIGS. 1A through 1C are used to explain these circumstances in more detail as follows. FIGS. 1A through FIG. 1C are schematic views showing a case in which an information transfer master, onto which no lubricant has been coated, is applied to magnetic transfer. In the figures, 1 indicates the information transfer master, 2 indicates the magnetic recording medium, 3 indicates the lubricant, and 4 indicates either a single or multiple layers including a magnetic layer. FIG. 1A shows the pre-transfer appearance. FIG. 1B shows the post-transfer appearance of the first layer. As is understood when comparing FIG. 1A with FIG. 1B, some parts of the lubricant 3′ on the magnetic recording medium migrates onto the information transfer master 1 and adheres thereto. In this case, depending on the type of lubricant present, as time passes, the lubricant 3 spreads onto the magnetic recording medium, and the lubrication layer 3 becomes even and thin as shown in FIG. 1C. In other words, there is concern that when the lubricant for the magnetic recording medium adheres to the information transfer master 1, lubricant 3 on the surface of the magnetic recording medium will be reduced, the lubricant 3 will no longer perform its originally intended function as a lubricant, and if the head contacts the magnetic recording medium, head crashing will occur, thereby causing problems.

Also, after a large amount of lubricant has adhered to the information transfer master 1, the lubricant which adhered to the information transfer master will re-adhere to the magnetic recording medium as shown in FIG. 2. In this case, there is concern that the lubrication layer 3″ on the surface of the magnetic recording medium will form a thick layer, lubricant 3″ will adhere to the floating face of the slider, and head contamination or head crashing will be caused.

As shown in FIG. 9, the floating amount of the head in magnetic disks is rapidly decreasing year by year as surface density improves and solving the above-mentioned problems becomes more important.

Regarding these problems, Patent Documents 4 (Japanese Unexamined Patent Application Publication No. 2005-50477) and 5 (Japanese Unexamined Patent Application Publication No. 2001-34939) proposed a method of applying the lubricant to the surface of the information transfer master from the beginning. However, simply applying the lubricant to the surface of the information transfer master from the beginning is an insufficient solution to the aforementioned problems.

Objects of the present patent application are to resolve the aforementioned problems and provide superior bonding between the information transfer master and the slave medium, thereby providing an information transfer master that can reliably transfer information to the slave medium and a method of magnetic transfer.

### SUMMARY

In accordance with an aspect of the embodiments, an information transfer master has a servo information pattern to be magnetically transferred to a magnetic recording medium having a lubrication layer thereon; and a contact surface to contact the magnetic recording medium and having surface free energy that is 45 mN/m or less when the servo information pattern is magnetically transferred.

In accordance with another aspect of the embodiments, an information transfer method has steps of contacting an information transfer master on which a servo information pattern is formed to a magnetic recording medium having a lubrication layer thereon; and applying a magnetic field to the information transfer master where the surface free energy of a contact surface of the information transfer master is 45 mN/m or less.

### BRIEF DESCRIPTION OF THE DRAWINGS

FIG. 1A shows a case in which an information transfer master, on which there is no coating of lubricant, is applied to magnetic transfer.

FIG. 1B shows a case in which an information transfer master, on which there is no coating of lubricant, is applied to magnetic transfer.

FIG. 1C shows a case in which an information transfer master, on which there is no coating of lubricant, is applied to magnetic transfer.

FIG. 2. shows the [resulting] appearance when the lubricant which had adhered to the information transfer master is re-adhered to the magnetic recording medium.

FIG. 3A exemplifies a method of manufacturing the information transfer master.

FIG. 3B exemplifies a method of manufacturing the information transfer master.

FIG. 3C exemplifies a method of manufacturing the information transfer master.

FIG. 4 exemplifies a servo pattern.

FIG. 5 is a graph showing the relationship between the thickness of the surface layer of the information transfer master and the bad sector ratio of the servo sector.

FIG. 6 is a graph showing the UV light exposure time, the transfer count, and the adhesion ratio of the surface layer of the information transfer master.

FIG. 7 is a graph showing the relationship between the heating temperature and the transfer count.

FIG. 8 is a graph showing the relationship between the surface energy and the transfer count.

FIG. 9 is a graph showing the trend of the floating amount and surface density of the head of magnetic disks.

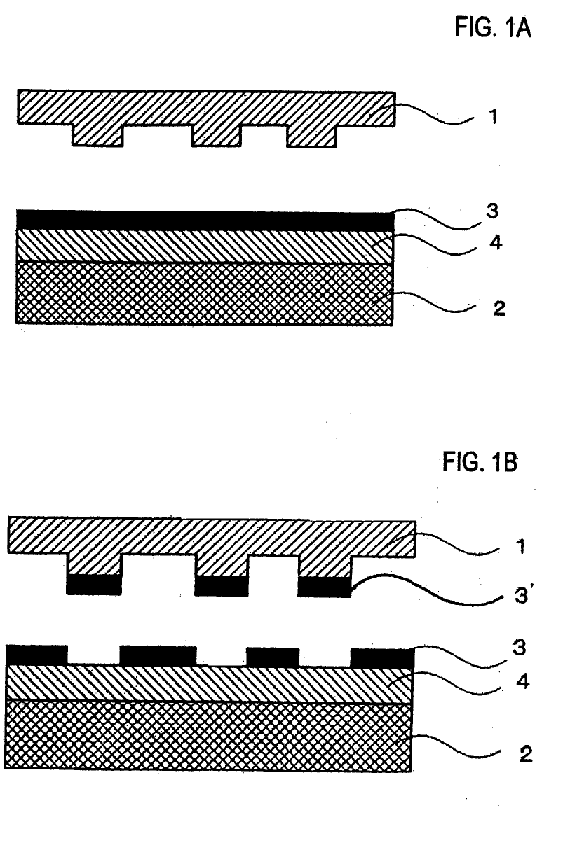

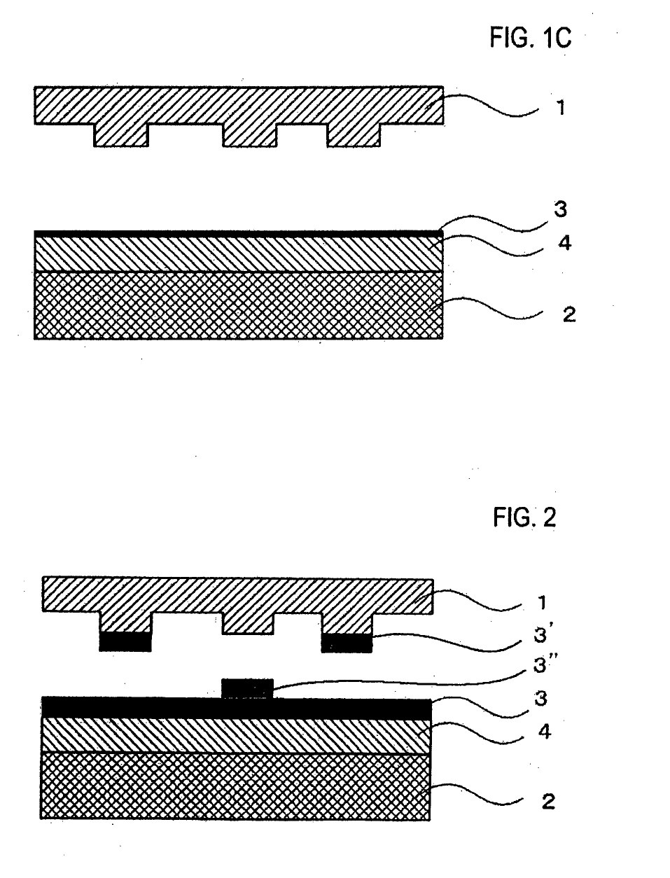

### DETAILED DESCRIPTION

Figures and examples are used to explain the embodiment of the present patent application hereinafter. Note, the figures, examples and explanations are intended to exemplify the present patent application and are not intended to limit the scope of the present patent application. As long as the general intent of the present patent application is maintained, it goes without saying that another embodiment may fall within the category of the present patent application. In the figures, identical symbols represent identical elements.

An information transfer master according to the present application forms a servo information pattern which is magnetically transferred to a magnetic recording medium having a lubrication layer on the surface thereon. The surface free energy of the surface layer opposite to the above-mentioned magnetic recording medium when transferring the above-mentioned servo information pattern is 45 mN/m or less.

By magnetically transferring the servo information pattern to the magnetic recording medium, which has a lubrication layer on the surface thereof, using an information transfer master under such conditions, migration of the lubricant on the magnetic recording medium or other foreign matter onto the surface of the information transfer master can be restrained. Outstanding bonding can thereby be provided between the information transfer master and the slave medium, and an information transfer master that can reliably transfer information to the slave medium can be obtained.

More specifically, because it is difficult for the lubricant of the slave medium to adhere to the information transfer master, it is possible to solve the floating obstacle problem that occurs when the lubricant on the surface of the magnetic recording medium was reduced due to migration of the lubricant onto the information transfer master. Also, problems such as the distance between the information transfer master and the magnetic recording medium being increased by the lubricant adhering to the information transfer master or other foreign matter, the magnetic field applied to the slave medium being blurred, and the S/N ratio being decreased or local loss of information can be restrained. Furthermore, problems caused when the lubricant which migrated onto the information transfer master migrates instead onto the magnetic recording medium, a thick lubrication layer forms on the surface of the magnetic recording medium, and lubricant adheres to the floating face of the slider, thereby causing head contamination or head crashing, also decrease. Note, the information transfer master according to the present patent application can also easily adopt the conventional process in which magnetic transfer is performed using the magnetic recording medium after the lubricant has been applied. It is preferable for this surface free energy to be 25 mN/m or less.

Furthermore, it is preferable for the aforementioned surface free energy to be less than the surface free energy of the above-mentioned lubrication layer. By adopting these conditions, it becomes possible to more reliably restrain the migration of the lubricant or other foreign matter on the slave medium onto the surface of the information transfer master. No particular limits have been placed on the information transfer master according to the present patent application, and as long as the requirements of the present pattern application are satisfied, the transfer of any type of information is acceptable. Such information transfer masters are typically configured such that minute surface irregularity patterns on boards are covered by soft magnetic layers composed from Fe—Co, for example. These minute surface irregularity patterns are typically manufactured on silicon boards or glass boards by implementing processes such as photofabrication, sputtering, or etching.

Even the magnetic recording medium (slave medium) according to the present patent application is not particularly limited herein, and can also be a recording medium such as an in-plane medium, SFM (Synthetic Ferric Coupled Media), vertical recording medium, or patterned medium used in a hard disk apparatus.

A lubrication layer exists on the surface of this magnetic recording medium. This lubrication layer is not particularly limited herein and can also be formed by a known method using a known lubricant. A lubricant including a fluorinated resin, a lubricant mainly comprising a fluorinated resin (90% or more by weight, for example), or a lubricant solely comprising a fluorinated resin shows outstanding lubricating properties for long periods of time with thin layers is preferred as the lubricant according to the present patent application. Compounds including carbon, fluorine, and optional hydrogen, and even compounds including ether bonds can be mentioned as such fluorinated resins. More specifically, straight-chain fluorine-containing polyether can also be mentioned. Perfluoropolyether, a fluorine-containing polyether including absolutely no hydrogen, also falls under this category. Note, in many cases it is preferable for such fluorine-containing resins to be terminated by a trifluoromethyl group. The trifluoromethyl group has lower surface energy compared with the corresponding methyl group or another hydrocarbon series functional group. In this case, this is because the surface energy can be efficiently reduced. There are no particular limitations on the thickness of the lubrication film according to the present patent application, but there are disadvantages in having a lubrication layer that is too thick since the floating amount of the magnetic disk head will increase.

As long as the surface free energy requirements are satisfied, any configuration of the surface layer of the information transfer master is acceptable. The surface layer can be in either solid form or in liquid form. For example, when providing a protection layer on the magnetic layer of the information transfer master, the protection layer can correspond to the surface layer. Providing a special layer is also acceptable. The special layer can have another function such as that of a lubrication layer.

It is often preferred for this surface layer to be manufactured from the same material as the lubrication layer which comprises the lubrication layer of the slave medium. Because of their high mutual affinity, it is often difficult for unidirectional migration of matter from the slave medium to the information transfer master or for the opposite migration of matter to occur.

Also, from the perspective of the material, it is preferable for the surface layer to include a fluorinated resin, for the fluorinated resin to be a straight-chain fluorine-containing polyether, or for the fluorinated resin to be a fluorinated resin which is terminated by a trifluoromethyl group. This is because such resin generally remains on the information transfer master and has difficulty migrating to the slave medium. In this case, the meaning of this term is similar to that of the lubrication layer used for lubricating the aforementioned slave medium.

There are no particular limitations on the thickness of the surface layer, but it has become clear that it is preferable for the thickness thereof to be 1 nm or greater. This is because it is conceivable that if the surface layer is thinner than this, restraining the migration of lubricant or any other foreign matter from the magnetic recording medium to the surface of the information transfer master becomes difficult.

In terms of the relationship with the film thickness of the lubrication layer, it is preferable for the film thickness of the surface layer to be less than or equal to the film thickness of the lubrication layer. Currently, the lubrication layer is 0.9 nm, so it is desirable to have low surface energy with a surface layer of 1 nm or greater, which is greater than or equal to the film thickness of the lubrication layer. In this way, the surface energy can be reduced and the abrasion strength can be improved.

It is preferable for the surface layer according to the present patent application to substantively be chemically bonded to the underlying layer. This is because if the surface layer is substantively chemically bonded, migration to the slave medium becomes even more difficult. In addition, when a layer is “substantively chemically bonded,” requiring confirmation that chemical bonding actually occurred is not necessary. Having a component which is not washed away by cleaning using a solvent and adheres to the underlying layer is sufficient.

Specifically, it is preferable for the ratio of the component which adheres to the layer underneath, in other words the adhesion ratio of the surface layer to the underlying layer, to be 80% or greater. The adhesion ratio of the surface layer can be found by extracting the surface layer of the information transfer master using a solvent such as 2,3-dihydro-decafluoropentane or hexafluoroisopropanol, then obtaining the ratio of the pre-extraction film thickness when the film thickness of the surface layer was in a steady state to the post-extraction film thickness. Film thickness here is the average film thickness. Time for the extraction to indicate a steady value for the film thickness of the surface layer is sufficient. Typically about 1 minute is sufficient for the extraction. The film thickness can be measured using X-ray photoelectron spectroscopy, Fourier transform infrared spectrophotometry, or a method which uses an ellipsometer. Finding the ratio of pre-extraction weight, when the extraction amount was in a steady state, to the non-extracted material weight is also acceptable. An adhesion ratio of 95% or greater is preferable, but a ratio of 98% or greater is even more preferable.

There are also cases where the surface layer according to the present patent application can simply consist of the desired material being applied to the information transfer master, but in order to satisfy such adhesion ratio conditions, cleaning the surface layer using a solvent, irradiating the surface layer with high-energy rays, or heat treating the surface layer is useful. Any combination of the above is also useful.

Weakly adhering portions such as those adhering by way of physisorption can be removed by cleaning. Fluorinated solvents such as 2,3-dihydro-decafluoropentane and hexafluoroisopropanol can be mentioned as examples of solvents which meet this objective.

When irradiating the surface layer with high-energy rays, it is believed that chemical bonding between the surface layer and the underlying layer is promoted. There are also treatments such as ultraviolet ray treatment, Xenon Excimer laser treatment, electron beam treatment, and infrared ray treatment, but ultraviolet treatment is highly practical and therefore preferable. This is because it is possible to securely bond the material forming the surface layer using the underlying layer, thereby restraining migration from the surface layer to the slave medium more reliably. In the case of ultraviolet rays, the surface energy can also be reduced by way of irradiation. By substantively chemically bonding [the aforementioned material] using high-energy rays, the low surface energy state can be maintained. In the case of ultraviolet ray treatment, when the energy of the ultraviolet rays is greater than the work function of the master, photoelectrons emerge from the master, thereby increasing the bonding efficiency of the lubricant.

Ultraviolet ray treatment, Xenon Excimer laser treatment, electron beam treatment, heat treatment, and conditions for combinations of these treatments can be determined accordingly through experimentation. Generally, ultraviolet ray treatments consist of irradiating inert gasses such as nitrogen or argon at wavelengths between 150 and 200 nm in normal atmosphere. Preferable heat treatment conditions are heating at temperatures between 100 and 150° C. for 30 to 90 minutes. It goes without saying that combining the aforementioned cleaning after these treatments is also acceptable.

Here the term “underlying layer” means the layer in the information transfer master which is underneath the surface layer. If the surface layer according to the present patent application exists directly on top of a protection layer, this term applies to the protection layer. If the surface layer according to the present patent application exists directly on top of a magnetic layer, this term applies to the magnetic layer.

From the above viewpoint, another desirable aspect is that fact that the disjoining pressure of the surface layer according to the present patent application is within 100±50% of the disjoining pressure of the lubricant for the slave medium. “Disjoining pressure” means the pressure that must be applied to a thin liquid film on top of a solid body to keep the film thickness thereof at a certain value. If a material with a different disjoining pressure contacts this material, there is a tendency for matter to migrate from the material having the lower disjoining pressure to the material having the higher disjoining pressure. This is because such migration of matter can be restrained. However, the disjoining pressure can be found as explained below.

Next, working examples and comparative examples of the present patent application are explained in detail hereinafter. Nevertheless, the following evaluation method has been adopted.

### (Surface Free Energy Measurement)

The contact angles of dionized water and diiodemethane relative to the target film were measured, then the surface free energy was calculated using the following equation.

If γS represents the surface free energy of a solid material, γL represents the surface free energy of a liquid material, θSL represents the contact angle of a sold material/liquid material, and γSL represents the boundary surface free energy of a solid material/liquid material, then the Young's formula shown in Expression (2) is established.

γS=γL·cos θSL+γSL (2)

Bonding work WSL, which is the energy that stabilizes when a liquid bonds to a solid surface, follows Dupre's formula (3).

γS+γL=WSL+γSL (3)

The Young-Dupre formula (4), which is derived from the two above formulas, finds the bonding work from the surface free energy and contact angle of the liquid.

WSL=γL(1+cos θSL) (4)

When the geometric average of each component of the surface free energy is applied to the bonding work, formula (5) is established.

WSL=2√(γSd·γLd)+2≈(γSh·γLh) (5)

In this formula, d and h represent the dispersion component and the hydrogen bonded component, respectively.

If two types of fluid (i,j) are used, the following bonding work relationship is established.

$$( \begin{matrix}{W}_{SL}^{i} \\ {W}_{SL}^{j}\end{matrix} ) = 2 ( \begin{matrix}\sqrt{{γ}_{L}^{d , i}} & \sqrt{{γ}_{L}^{h , i}} \\ \sqrt{{γ}_{L}^{d , j}} & \sqrt{{γ}_{L}^{h , j}}\end{matrix} ) ( \begin{matrix}\sqrt{{γ}_{S}^{d}} \\ \sqrt{{γ}_{S}^{h}}\end{matrix} ) \qquad ( 1 )$$

Therefore, if the contact angle is measured for two types of liquid and the bonding work is found, then the surface free energy for solids can be found for each component according to the following relationship. This relational expression is called the Fowkes expression. Also, the surface free energy γs=γsd+γsh can be found from this relational expression.

$$( \begin{matrix}\sqrt{{γ}_{S}^{d}} \\ \sqrt{{γ}_{S}^{h}}\end{matrix} ) = \frac{1}{2} {( \begin{matrix}\sqrt{{γ}_{L}^{d , i}} & \sqrt{{γ}_{L}^{h , i}} \\ \sqrt{{γ}_{L}^{d , j}} & \sqrt{{γ}_{L}^{h , j}}\end{matrix} )}^{- 1} ( \begin{matrix}{W}_{SL}^{i} \\ {W}_{SL}^{j}\end{matrix} ) \qquad ( 2 )$$

Specifically, the surface free energy γs=γsd+γsh was found according to the following equation using the data in the following table.

$$( \begin{matrix}\sqrt{{γ}_{S}^{d}} \\ \sqrt{{γ}_{S}^{h}}\end{matrix} ) = \frac{1}{2} {( \begin{matrix}\sqrt{21.8} & \sqrt{51.0} \\ \sqrt{49.5} & \sqrt{1.3}\end{matrix} )}^{- 1} ( \begin{matrix}72.8 ( 1 + cos {θ}_{W} ) \\ 50.8 ( 1 + cos {θ}_{D} )\end{matrix} ) \qquad ( 3 )$$

In the above equation, θw represents the contact angle of water, and θD represents the contact angle of diiodemethane.

TABLE 1

| | | | Surface tension |
|---|---|---|---|
| | Surface tension | Surface tension (dispersion | (polar |
| Liquid | (total: γL^{d}) | component: γL^{d}) | component: γL^{h}) |
| Water | 72.8 | 21.8 | 51.0 |
| Diiode- | 50.8 | 49.5 | 1.3 |
| methane | | | |

Units are mN/m
Surface tension (total) is the surface tension of a typical liquid

### (Adhesion Ratio)

One information transfer master was immersed in 1000 ml of 2,3-dihydro-decafluoropentane at room temperature for 1 minute, removed, dried off, and then the percentage of film thickness of the pre-immersion surface layer relative to the film thickness of the post-drying surface layer was found.

### (Disjoining Pressure)

The lubrication film thickness dependency of the surface tension (surface free energy) was found, then expressed as function γ(h) of the film thickness h. Disjoining pressure P(h) can be found by the expression P(h)=−dγ/dh.

### (Bad Sector Ratio of Servo Sectors)

The bad sector ratio of servo sectors expresses the ratio of servo sectors recorded on a magnetic disk medium that cannot be used for recording or playback.

Furthermore, “transfer count” below means the slave medium count for which transfer was possible until the bad sector ratio of the servo sectors reached 1%.

### EXAMPLE 1

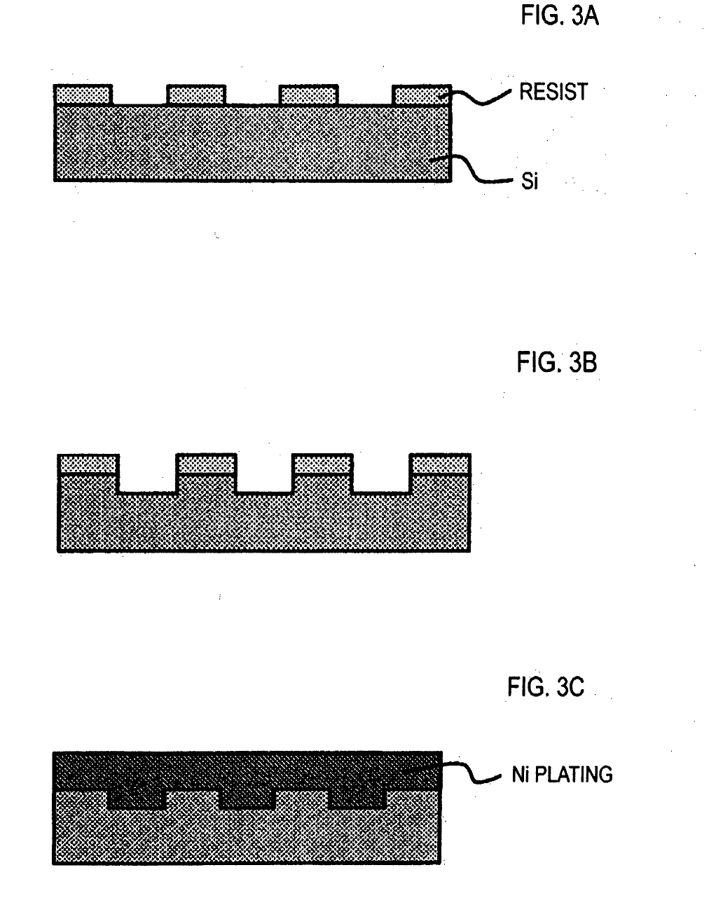

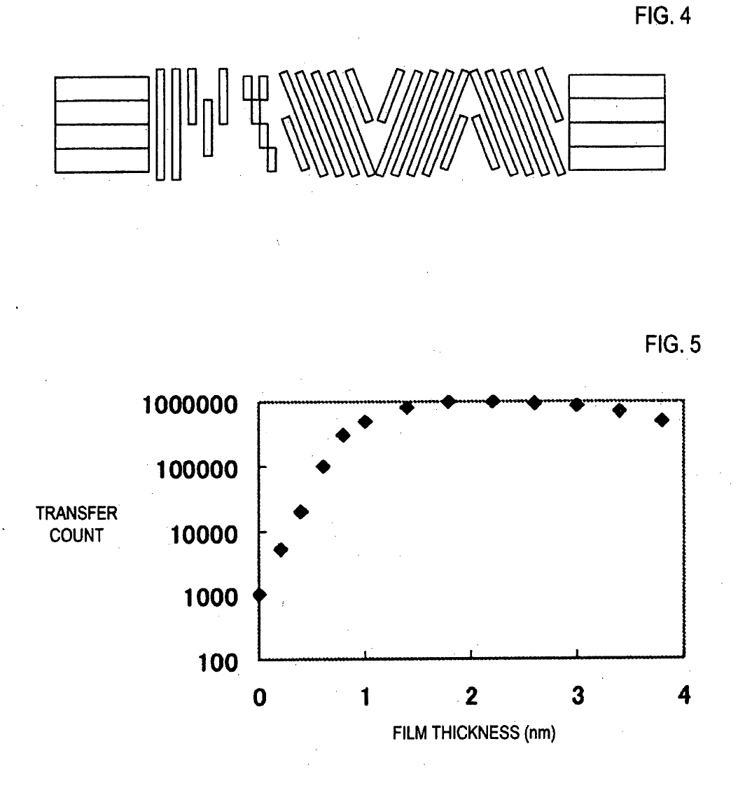

As shown in FIG. 3(a), electron beam resist (zep-520) was applied onto an 8″ Si wafer, and concavo-convex shapes corresponding to a servo pattern were developed using an electron beam exposure system. A servo pattern is shown in FIG. 4.

Next, RIE (reactive ion etching) was performed using SF6 gas, obtaining the concavo-convex shapes with a depth of 100 nm shown in FIG. 3(b). RIE was performed under a pressure of 1 Pa at an SF6 volume flow rate of 15 ml/minute for 60 seconds.

Incidentally, oxygen gas was used for the ashing removal of the resist. Ashing was performed under a pressure of 10 Pa at an oxygen volume flow rate of 100 ml/minute for 3 minutes.

Next, after Ni was sputtered to form an electrode film, as shown in FIG. 3(c), 300 μm Ni plating was implemented by performing electroplating.

After the Ni was stripped away, the wafer was routed into a 2.5-inch shape by a routing apparatus not shown here.

Next, a magnetic film was formed on the side having the irregular Ni surface. An FeCo material having high magnetic permeability was used as the magnetic film. Lastly, an information transfer master is obtained when a protection film is formed by DLC (diamond-like carbon) or sputter carbon. In the current patent application, a protection film was formed by DLC. This surface free energy was 55 mN/m.

### EXAMPLE 2

The aforementioned information transfer master was used in its original state when performing endurance tests on magnetic transfer. The slave medium which was used is a 2.5-inch disk-shaped magnetic medium for hard disks. A lubrication layer comprising a straight-chain perfluoropolyether (FOMBLIN Z TETRAOL) terminated by a propylene glycol group with a thickness of 1.25 nm was provided on the surface opposite the information transfer master. The surface free energy of the slave medium, in other words the surface free energy of the lubrication layer of the slave medium was 18 mN/m, so the disjoining pressure was 4×106 Pa.

As a result, when 10,000 transfers were performed, contamination supplied from the magnetic recording medium adhered to the information transfer master, and the bad sector ratio exceeded 5% near the perimeter of all servo sectors due to faulty bonding, thereby making the precise recording of servo information impossible.

### EXAMPLE 3

On the other hand, when straight-chain perfluoropolyether terminated by a trifluoromethyl base was coated onto the information transfer master manufactured above, the information transfer master was irradiated by 172-nm UV light with a luminance of 13 mW in a nitrogen atmosphere without being heated, the soluble components were removed by immersing the information transfer master into 1000 ml of 2,3-dihydro-decafluoropentane for 1 minute at room temperature after UV irradiation, the information transfer master was dried out, and an information transfer master having a surface film with a thickness of 1.5 nm was manufactured. When this information transfer master was used in magnetic transfer, the bad sector ratio of the servo sectors did not reach 1% even after 1 million transfers were performed during magnetic transfer. Furthermore, in this case, the DLC layer corresponds to the underlying layer.

The surface free energy of this information transfer master, in other words the surface free energy of the surface layer of the information transfer master, was 15 mN/m, and the disjoining pressure was 2.5×106 Pa. Also, the adhesion ratio of the surface layer was 99%.

### EXAMPLE 4

The surface layer of the information transfer master was changed to various thicknesses, and the transfer count at which the bad sector ratio of servo sectors became 1% was evaluated. The result of the evaluation is shown in FIG. 5. When there was a surface layer, except for the film thickness, an information transfer master similar to that in Example 3 was manufactured.

From this result, it was confirmed that without a surface layer, the bad sector ratio became 1% after 1000 transfers, but when the film thickness was 1.5 nm, the bad sector ratio did not reach 1% after 1 million transfers. Furthermore, when the film thickness is thicker, a decreasing trend in the bad sector ratio indicates that the increased space between the magnetic recording medium and the information transfer master could be due to the occurrence of signal transfer faults.

### EXAMPLE 5

Except for when the thickness of the surface layer of the information transfer master is established at 1.2 nm and the UV light treatment time was changed, an information transfer master having a surface layer similar to that in Example 3 was manufactured.

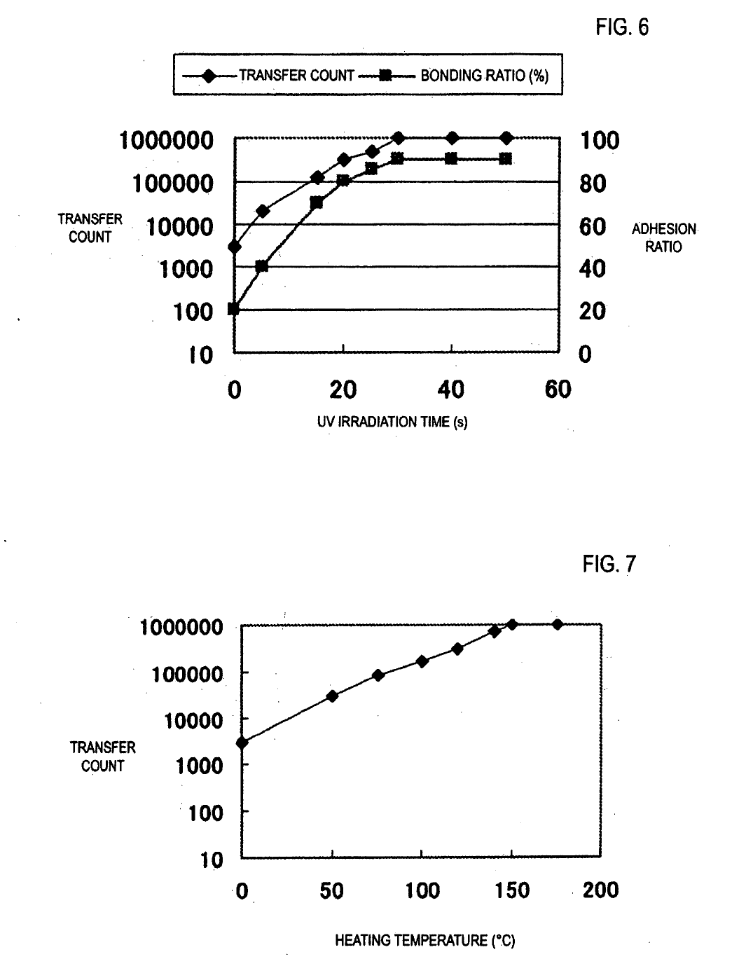

FIG. 6 shows the UV light exposure time, the transfer count, and the adhesion ratio of the surface layer of the information transfer master. It turns out that the transfer count increases as the UV light exposure time increases. Also, the adhesion ratio increased to about 95% in a nearly linear fashion up to a UV light exposure time of 30 seconds.

### EXAMPLE 6

Instead of UV light irradiation, straight-chain perfluoropolyether which is terminated by propylene glycol was used as a lubricant, and an information transfer master having a surface layer similar to that in Example 3, except for heat treatment which was performed for 1 hour, was manufactured. FIG. 7 shows the relationship between the heating temperature and the transfer count. It can be understood here that the transfer count increases when the heating temperature is high. When the heating temperature was 130° C. or greater, the transfer count reached 1 million. Furthermore, the film thickness of lubrication in the present example was 1.5 nm, the surface free energy of the surface layer of the information transfer master was 16.5 mN/m, and the disjoining pressure was 2.8×106 Pa. Also, the adhesion ratio of the surface layer was 99%.

### EXAMPLE 7

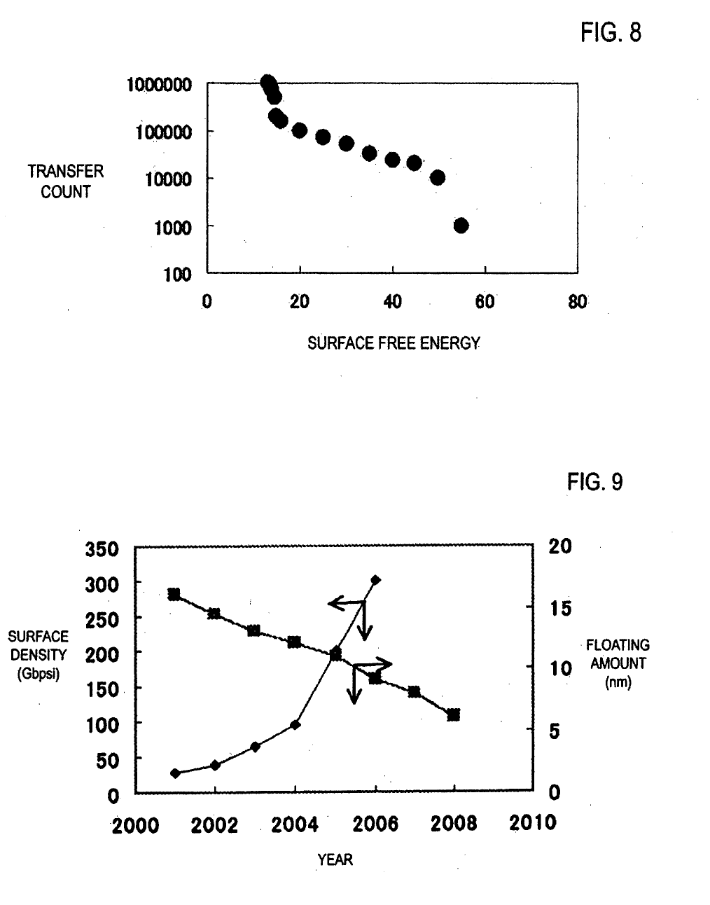

Next, after checking the transfer count at which the bad sector ratio of the servo sectors reached 1% when the surface energy was changed by changing the film thickness in Example 3, the transfer count was found to be as shown in FIG. 8. Thus, by forming a surface layer, the transfer count becomes 20,000 when the surface energy becomes 45 mN/m or less, so if the information transfer master is cleaned, it can be applied to production. Also, if the surface energy becomes 25 mN/m or less, then there are cases in which it can withstand production even without being cleaned. In addition, when the surface free energy of the surface of the information transfer master (the surface of the surface layer in the case of the present example) is less than that of the surface of the magnetic recording medium (the lubrication layer in the case of the present example) on which the servo information is recorded, the lubrication layer of the magnetic recording medium does not migrate to the information transfer master, so it is believed that there is also no re-adhesion from the information transfer master.

What is claimed is:

1. An information transfer master comprising:
servo information pattern to be magnetically transferred to a magnetic recording medium having a lubrication layer thereon; and
a contact surface to be contacted to the magnetic recording medium and having surface free energy that is 45 mN/m or less when said servo information pattern is magnetically transferred.

2. The information transfer master according to claim 1, wherein said surface free energy is 25 mN/m or less.

3. The information transfer master according to claim 1, wherein said surface free energy is less than the surface free energy of said lubrication layer.

4. The information transfer master according to claim 1, wherein said surface layer is manufactured from the same material as the lubricant which comprises said lubrication layer.

5. The information transfer master according to claim 1, wherein said surface layer comprises a fluorinated resin.

6. The information transfer master according to claim 5, wherein said fluorinated resin is a fluorinated resin which is terminated by a trifluoromethyl group.

7. The information transfer master according to claim 5, wherein said fluorinated resin is a straight-chain fluorine-containing polyether.

8. The information transfer master according to claim 1, wherein the film thickness of said surface layer is 1 nm or greater.

9. The information transfer master according to claim 1, wherein the film thickness of the said surface layer is less than or equal to the film thickness of said lubrication layer.

10. The information transfer master according to claim 1, wherein said surface layer is substantively chemically bonded to the underlying layer thereof.

11. The information transfer master according to claim 10, wherein the adhesion ratio of said surface layer in relation to said underlying layer is 80% or greater.

12. The information transfer master according to claim 1, wherein said surface layer is cleaned by a solvent.

13. The information transfer master according to claim 1, wherein said surface layer is treated by ultraviolet ray treatment, Xenon Excimer laser treatment, electron beam treatment, infrared ray treatment, heating treatment, or groups of treatments selected from a combination of these treatments.

14. The information transfer master according to claim 1, wherein the disjoining pressure of said surface layer is within 100±50% of the disjoining pressure of said lubrication layer.

15. An information transfer method comprising steps of:
contacting a information transfer master on which servo information pattern is formed to a magnetic recording medium having a lubrication layer thereon; and
applying magnetic field to the information transfer master where the surface free energy of a contact surface of the information transfer master is 45 mN/m or less.
